(19) United States
(12) Patent Application Publication
(10) Pub. No.: US 2025/0191503 A1
(43) Pub. Date: Jun. 12, 2025

(54) ELECTRONIC DEVICE AND OPERATION METHOD THEREOF

(71) Applicant: Samsung Electronics Co., Ltd., Suwon-si (KR)

(72) Inventor: Jonghwan KIM, Suwon-si (KR)

(21) Appl. No.: 19/052,973

(22) Filed: Feb. 13, 2025

Related U.S. Application Data
(63) Continuation of application No. PCT/KR2023/012509, filed on Aug. 23, 2023.

(30) Foreign Application Priority Data
Sep. 29, 2022 (KR) 10-2022-0124666
Dec. 21, 2022 (KR) 10-2022-0180885

(51) Int. Cl. G09G 3/00; G06T 5/80

(52) U.S. Cl. CPC G09G 3/001; G06T 5/80

(57) ABSTRACT

Provided is an electronic device including: a projector, a memory storing one or more instructions, and at least one processor, comprising processing circuitry, individually and/or collectively, configured to execute the one or more instructions stored in the memory and to: obtain modeling information corresponding to a projection space from modeling information about a surrounding space, obtain projection object content by correcting a shape of standard object content, based on the modeling information corresponding to the projection space, determine an action of the projection object content, based on the modeling information corresponding to the projection space, and project, through the projector, projection content including the projection object content performing the determined action, onto the projection space.

### CROSS-REFERENCE TO RELATED APPLICATIONS

This application is a continuation of International Application No. PCT/KR2023/012509 designating the United States, filed on Aug. 23, 2023, in the Korean Intellectual Property Receiving Office and claiming priority to Korean Patent Application Nos. 10-2022-0124666, filed on Sep. 29, 2022, and 10-2022-0180885, filed on Dec. 21, 2022, in the Korean Intellectual Property Office, the disclosures of each of which are incorporated by reference herein in their entireties.

### BACKGROUND

### Field

The disclosure relates to an electronic device and an operating method thereof, and for example, to an electronic device for projecting content, and an operating method thereof.

### Description of Related Art

A technology in which a virtual image overlaps the real world is referred to as augmented reality. Augmented reality is distinguished from virtual reality, in which a user interacts with a surrounding environment in a virtual space, in that a virtual image is displayed by being overlapped with a physical real world.

Various types of projectors are being developed according to the development of optical technology. A projector is an electronic device that displays an image by projecting light onto a certain space or plane, and may realize augmented reality technology by projecting a virtual image onto the real world.

### SUMMARY

An electronic device according to an example embodiment may include a projector, a memory storing one or more instructions, and at least one processor, comprising processing circuitry, individually and/or collectively, configured to execute the one or more instructions stored in the memory.

According to an example embodiment, at least one processor, individually and/or collectively, may be configured to obtain modeling information corresponding to a projection space from modeling information about a surrounding space.

According to an example embodiment, at least one processor, individually and/or collectively, may be configured to obtain projection object content by correcting a shape of standard object content, based on the modeling information corresponding to the projection space.

According to an example embodiment, at least one processor, individually and/or collectively, may be configured to determine an action of the projection object content, based on the modeling information corresponding to the projection space.

According to an example embodiment, at least one processor, individually and/or collectively, may be configured to control the electronic device to project, through the projector, projection content including the projection object content performing the determined action, onto the projection space.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an electronic device projecting virtual content onto the real world, according to various embodiments;

FIG. 2 is a block diagram illustrating an example configuration of an electronic device according to various embodiments;

FIG. 3 is a block diagram illustrating an example configuration of an electronic device according to various embodiments;

FIG. 4 is a diagram illustrating an example configuration of an operating module of a processor inside an electronic device, according to various embodiments;

FIG. 5 is a diagram illustrating an electronic device being rotated, according to various embodiments;

FIG. 6 is a diagram illustrating an electronic device obtaining modeling information about surroundings, according to various embodiments;

FIG. 7 is a diagram illustrating an electronic device identifying a projection direction, according to various embodiments;

FIG. 8 is a diagram illustrating an electronic device correcting a shape of object content, based on modeling information corresponding to a projection space, according to various embodiments;

FIG. 9 is a diagram illustrating an electronic device correcting a shape of object content, based on modeling information corresponding to a projection space, according to various embodiments;

FIG. 10 is a diagram illustrating an electronic device correcting a form of standard object content, based on modeling information corresponding to a projection space, according to various embodiments;

FIG. 11 is a diagram illustrating an electronic device determining a movement action of object content according to a projection space, according to various embodiments;

FIG. 12 is a diagram illustrating an electronic device recognizing a variance in a projection space and controlling an action of projection object content according to the variance, according to various embodiments;

FIG. 13 is a diagram illustrating an electronic device adjusting a size of background content, according to various embodiments;

FIG. 14 is a flowchart illustrating an example method of obtaining modeling information about a surrounding space, according to various embodiments;

FIG. 15 is a flowchart illustrating an example method of operating an electronic device, according to various embodiments; and

FIG. 16 is a flowchart illustrating an example process of differently controlling an action of projection object content, based on a depth value difference of a projection space, according to various embodiments.

### DETAILED DESCRIPTION

A method of operating an electronic device, according to an embodiment, may include obtaining modeling information corresponding to a projection space from modeling information about a surrounding space.

The method according to an embodiment may include obtaining projection object content by correcting a shape of standard object content, based on the modeling information corresponding to the projection space.

The method according to an embodiment may include determining an action of the projection object content, based on the modeling information corresponding to the projection space.

The method according to an embodiment may include projecting projection content including the projection object content performing the determined action, onto the projection space.

A non-transitory computer-readable recording medium, according to an embodiment, may have recorded thereon a program which, when executed on a computer, causes an electronic device to perform an operating method of an electronic device, the operating method including obtaining modeling information corresponding to a projection space from modeling information about a surrounding space.

According to an embodiment, the non-transitory computer-readable recording medium may have recorded thereon the program which, when executed on the computer, causes an electronic device to perform an operating method including obtaining projection object content by correcting a shape of standard object content, based on the modeling information corresponding to the projection space.

According to an embodiment, the non-transitorycomputer-readable recording medium may have recorded thereon the program which, when executed on the computer, causes an electronic device to perform an operating method including determining an action of the projection object content, based on the modeling information corresponding to the projection space.

According to an embodiment, the non-transitory computer-readable recording medium may have recorded thereon the program which, when executed on the computer, causes an electronic device to perform an operating method including projecting projection content including the projection object content performing the determined action, onto the projection space.

Throughout the present disclosure, the expression “at least one of a, b or c” indicates only a, only b, only c, both a and b, both a and c, both b and c, all of a, b, and c, or variations thereof.

Hereinafter, various embodiments of the present disclosure will be described in greater detail with reference to the accompanying drawings. However, the present disclosure may be implemented in various different forms and is not limited to the various embodiments described herein.

Terms used in the present disclosure are described as general terms currently used in consideration of functions described in the present disclosure, but the terms may have different meanings according to an intention of one of ordinary skill in the art, precedent cases, or the appearance of new technologies. Thus, the terms used herein should not be interpreted only by its name, but have to be defined based on the meaning of the terms together with the description throughout the disclosure.

The terms used in the present disclosure are simply used to describe various embodiments, and are not intended to limit the present disclosure.

Throughout the disclosure, when a part is “connected” to another part, the part may not only be “directly connected” to the other part, but may also be “electrically connected” to the other part with another element in between.

“The” and similar directives used in the present disclosure, in particular, in claims, may indicate both singular and plural. Unless there is a clear description of an order of operations describing a method according to the present disclosure, the operations described may be performed in a suitable order. The present disclosure is not limited by the order of description of the described operations.

The phrases “some embodiments” or “an embodiment” appearing in various places in this disclosure are not necessarily all referring to the same embodiment.

Various embodiments of the present disclosure may be represented by functional block configurations and various processing operations. Some or all of these functional blocks may be implemented by various numbers of hardware and/or software configurations that perform particular functions. For example, the functional blocks of the present disclosure may be implemented by one or more microprocessors or by circuit configurations for a certain function. For example, the functional blocks of the present disclosure may be implemented in various programming or scripting languages. The functional blocks may be implemented by algorithms executed in one or more processors. In addition, the present disclosure may employ general techniques for electronic environment setting, signal processing, and/or data processing. Terms such as “mechanism”, “element”, “means”, and “configuration” may be used widely and are not limited as mechanical and physical configurations.

A connection line or a connection member between components shown in drawings is merely a functional connection and/or a physical or circuit connection. In an actual device, connections between components may be represented by various functional connections, physical connections, or circuit connections that are replaceable or added.

Terms such as “unit”, “-or/-er”, and “module” described in the disclosure denote a unit that processes at least one function or operation, which may be implemented in hardware or software, or implemented in a combination of hardware and software.

The term “user” in the disclosure denotes a person using an electronic device, and may include a consumer, an assessor, a viewer, an administrator, and an installation engineer.

Hereinafter, various example embodiments of the present disclosure will be described in greater detail with reference to accompanying drawings.

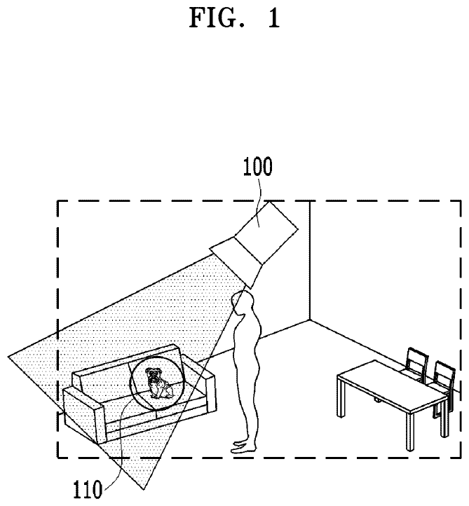

FIG. 1 is a diagram illustrating an electronic device projecting virtual content onto the real world, according to various embodiments.

Referring to FIG. 1, an electronic device 100 may be an electronic device capable of outputting an image. According to an embodiment, the electronic device 100 may be a projector configured to project an image onto a projection space. The electronic device 100 may be a fixed type or a movable type.

In FIG. 1, according to an embodiment, the electronic device 100 is provided on a ceiling to project projection content onto the surroundings. For example, the electronic device 100 may be connected to the ceiling through a connecting member.

According to an embodiment, the electronic device 100 may be a rotatable. For example, the electronic device 100 may rotate by being rotatably connected to the connecting member.

According to an embodiment, the electronic device 100 may include a projector. according to an embodiment, the projector may project the projection content.

In FIG. 1, when the electronic device 100 is provided on the ceiling and projects the projection content onto a floor surface, the floor surface is the projection space. When a projection direction and the projection space form a right angle, the projection direction of light projected onto a center of the projection space, or a direction opposite to the projection direction may be defined as a z-axis. Two axes perpendicular to each other on a plane perpendicular to the z-axis, e.g., a plane parallel to the floor surface, may be respectively defined as an x-axis and a y-axis.

According to an embodiment, the electronic device 100 may rotate based on each of the x-axis, the y-axis, and the z-axis. For example, rotating angles of the electronic device 100 rotating based on the x-axis, the y-axis, and the z-axis may be respectively referred to as a roll angle (φ), a pitch angle (θ), and a yaw angle (ψ). According to an embodiment, the rotating angles of the electronic device 100 rotating based on the x-axis, the y-axis, and the z-axis may vary depending on a structure of the electronic device 100 or a state in which the electronic device 100 is connected to a fixed surface. For example, in FIG. 1, the electronic device 100 may rotate by 180° in the y-axis and rotate by 360° in the x-axis and the y-axis, but is not limited thereto.

The electronic device 100 may not entirely rotate, but only some components included in the electronic device 100 may rotate. For example, the electronic device 100 may include a rotatable rotating member. Components, such as the projector, a camera sensor, and a depth sensor, may be arranged at the rotating member, and thus the components, such as the projector, the camera sensor, and the depth sensor, may rotate together when the rotating member rotates.

According to an embodiment, the electronic device 100 may include an image sensor and the depth sensor. According to an embodiment, the image sensor and the depth sensor may be realized as separate sensors, but are not limited thereto, and may be realized as one sensor. For example, the image sensor may be the depth sensor including a depth function.

According to an embodiment, the image sensor and the depth sensor may obtain information about a surrounding space while rotating according to rotation of the electronic device 100 or rotation of the rotating member.

According to an embodiment, the image sensor may include a camera. According to an embodiment, the image sensor may obtain a surrounding space image by photographing the surrounding space while rotating.

According to an embodiment, the depth sensor may obtain depth information of the surrounding space while rotating.

According to an embodiment, the electronic device 100 may obtain modeling information about the surrounding space, based on the surrounding space image and the surrounding space depth information. The rotating angle for each axis varies when the electronic device 100 rotates and moves, and the electronic device 100 may generate the modeling information at a certain point according to the surrounding space image and the surrounding space depth information obtained at a certain angle.

According to an embodiment, modeling may denote creating a virtual space resembling a surrounding three-dimensional space. According to an embodiment, the modeling information may include color information, luminance information, and depth information according to the rotating angle for each axis of at least one of the electronic device 100 or the rotating member.

According to an embodiment, the electronic device 100 may identify the projection space. According to an embodiment, the projection space may denote a space or area onto which the projection content is projected.

According to an embodiment, the electronic device 100 may identify the projection space, based on a user direction. According to an embodiment, the electronic device 100 may photograph a user using the image sensor. According to an embodiment, the electronic device 100 may identify a user feature point from a user image obtained by photographing the user. According to an embodiment, the user feature point may be information for identifying a part of a body of the user.

According to an embodiment, the electronic device 100 may identify a body point of the user, based on the user feature point obtained from the user image. For example, the electronic device 100 may identify, from the user image, a pre-defined (e.g., specified) user feature point, such as the back of a head, an ear, a neck, a shoulder, a forehead, or a nose of the user.

According to an embodiment, the electronic device 100 may generate a stereoscopic figure corresponding to the part of the body of the user, by connecting the identified user feature points. For example, the electronic device 100 may generate the stereoscopic figure fit to the head of the user by connecting the user feature points.

According to an embodiment, the electronic device 100 may identify a location of a face of the user, based on the stereoscopic figure. According to an embodiment, the electronic device 100 may measure a degree the stereoscopic figure is tilted, and identify a direction the face of the user faces, according to the tilted degree.

According to an embodiment, the electronic device 100 may identify the projection space, based on the direction the face of the user faces. For example, when a point where the direction the face of the user faces and the surrounding space meet is considered a center, the electronic device 100 may identify an area having a certain interval from the center as the projection space.

According to an embodiment, the electronic device 100 may obtain modeling information corresponding to the projection space from the modeling information about the surrounding space. According to an embodiment, the electronic device 100 may identify, among the modeling information about the surrounding space, modeling information about the projection space located in the direction the face of the user faces, and obtain the same as the modeling information corresponding to the projection space.

According to an embodiment, the electronic device 100 may obtain the standard object content. According to an embodiment, the standard object content is content generated by a content manufacturer or the like, and may include a standard color, brightness, shape, and size set by the manufacturer. According to an embodiment, the standard object content may be manufactured to have a uniform size, shape, color, and brightness, when projected onto the projection space having a color, brightness, and space structure of a pre-determined standard value.

According to an embodiment, the standard object content may be a virtual image mimicking an actor, a movie character, an animation character, a real-world animal or an imaginary animal.

According to an embodiment, the electronic device 100 may receive the standard object content in various types and various forms, from an external server through a communication network. Alternatively, according to an embodiment, the electronic device 100 may receive selection on one or more pieces of the standard object content from the user, among pieces of the standard object content pre-stored in an internal memory. Alternatively, according to an embodiment, when the electronic device 100 is able to generate the standard object content, the electronic device 100 may newly generate the standard object content for a person, animal, or object included in an image input by the user.

According to an embodiment, the electronic device 100 may correct the standard object content, based on the modeling information.

Because the standard object content is manufactured to have a uniform size, shape, color, and brightness when projected onto the projection space having a color, brightness, and space structure of a pre-determined standard value, when the color, brightness, or space structure of the projection space does not have the standard value, the size, shape, color, or brightness of the standard object content projected onto such a projection space may also have different forms from the standard object content.

According to an embodiment, the electronic device 100 may correct the color, brightness, shape, and size of the standard object content, based on the modeling information corresponding to the projection space. According to an embodiment, by correcting the color, brightness, shape, and size of the standard object content, based on the modeling information corresponding to the projection space, the electronic device 100 may enable projection object content to have the size, color, brightness, or shape of the standard object content even when the projection space is not a space having the pre-determined standard value.

When the modeling information corresponding to the projection space includes a color or brightness different for each area, the electronic device 100 may correct colors, brightness, shapes, and sizes of partial areas configuring the projection object content, based on the modeling information corresponding to the projection space, according to an embodiment. For example, the electronic device 100 may correct a color, brightness, shape, and size for each of a plurality of areas, for example, for each pixel, configuring the standard object content.

According to an embodiment, the electronic device 100 may adjust a whole size of the standard object content, according to a distance between the user and the projection space.

When the standard object content is displayed in a same size in cases where the distance between the user and the projection space is close and the distance therebetween is far, the sense of reality may deteriorate.

According to an embodiment, the electronic device 100 may obtain each of depth information to the user and depth information to the projection space. According to an embodiment, the electronic device 100 may obtain the distance between the user and the projection space by calculating a difference value between the depth information to the user and the depth information to the projection space.

According to an embodiment, the electronic device 100 may adjust the whole size of the standard object content, based on the distance between the user and the projection space. For example, when the distance between the user and the projection space is a standard distance, the electronic device 100 may display the standard object content in a standard size, and when the distance between the user and the projection space is shorter than the standard distance, the electronic device 100 may correct the size of the standard object content such that the standard object content is displayed to the user in a size greater than the standard size. Also, when the distance between the user and the projection space is greater than the standard distance, the electronic device 100 may correct the size of the standard object content such that the standard object content is displayed to the user in a size smaller than the standard size.

According to an embodiment, the electronic device 100 may project the standard object content having the corrected color, brightness, shape, and size, onto the projection space.

In the present disclosure, content obtained by the electronic device 100 to be projected onto the projection space, by correcting the standard object content, will be referred to as the projection object content.

The electronic device 100 may obtain the projection object content by correcting the standard object content, based on the modeling information corresponding to the projection space, and project the projection object content onto the projection space.

According to an embodiment, the electronic device 100 may generate background content. According to an embodiment, the background content may be content around the projection object content.

According to an embodiment, the electronic device 100 may generate the background content, based on the modeling information corresponding to the projection space. For example, the electronic device 100 may determine at least one of a color or brightness of the background content, based on at least one of a color or brightness of the modeling information corresponding to the projection space.

The electronic device 100 may determine the brightness of the background content to a minimum value such that the projected background content is well recognized in the projection space.

According to an embodiment, the electronic device 100 may generate projection content including the projection object content and the background content. According to an embodiment, the electronic device 100 may project projection content 110 onto the projection space.

FIG. 1 illustrates a case where the projection object content included in the projection content 110 is a puppy. As shown in FIG. 1, when the projection object content is a virtual image mimicking an animal existing in the real world, the projection object content may be treated as a type of a virtual cyber animal. The user may use the projection object content by interact with the virtual cyber animal in various ways, for example, raise or play with the virtual cyber animal projected onto the projection space by the electronic device 100.

According to an embodiment, the projection object content may be a virtual image having movement. According to an embodiment, the electronic device 100 may control the movement of the projection object content. According to an embodiment, the electronic device 100 may control the movement of the projection object content, based on at least one of a pre-set period, a random period, or event occurrence.

According to an embodiment, the electronic device 100 may control the movement of the projection object content every pre-set (e.g., specified) period, for example, 5 seconds.

According to an embodiment, the electronic device 100 may control the projection object content to act in a pre-defined (e.g., specified) order. For example, the electronic device 100 may control the projection object content to perform an action of sitting, and control the projection object content to perform an action of walking after 5 seconds. After 5 seconds again, the electronic device 100 may control the projection object content to perform an action of sniffing a floor.

According to an embodiment, the electronic device 100 may control the projection object content to perform a random action. For example, the electronic device 100 may control the projection object content to perform an action of sitting, and after a certain time, for example, 3 seconds, control the projection object content to perform a certain action different from the previous action, for example, an action of sniffing a floor, and again after a certain time, for example, 7 seconds, control the projection object content to perform another certain action, for example, an action of walking.

According to an embodiment, the electronic device 100 may control the movement of the projection object content whenever an event occurs. According to an embodiment, the event occurrence may include a case in which the direction of the face of the user is changed by a threshold value or greater, and thus the location of the projection space is also changed by a threshold value or greater.

According to an embodiment, when the direction of the face of the user is changed by the threshold value or greater, the electronic device 100 may determine the projection space again in the direction the face of the user faces. According to an embodiment, when the projection space is changed, the electronic device 100 may determine the movement of the projection object content again.

According to an embodiment, the event occurrence may include receiving a projection object content action control signal from the user. According to an embodiment, the user may input the projection object content action control signal to the electronic device 100 using a method of taking a certain gesture or uttering a certain word.

According to an embodiment, when the user takes a pre-defined certain action or utters a pre-defined certain word, the electronic device 100 may receive the same as the projection object content action control signal and control the movement of the projection object content, based on the projection object content action control signal.

According to an embodiment, the electronic device 100 may also receive action information indicating an action performed by the standard object content when receiving the standard object content from the external server. When the standard object content is stored in the internal memory of the electronic device 100, the internal memory may also store action information for each standard object content.

According to an embodiment, the action information may be information indicating various features or actions of the standard object content. For example, the action information may be information indicating an action generally performed by an object according to an object type.

According to an embodiment, a content provider may generate, as the action information, various actions that may be generally performed by an object belonging to an object type, based on the object type. For example, when the object is a puppy, the content provider may generate, as the action information, various types of actions that are generally performed by the puppy, for example, an action of wagging a tail, an action of breathing with a tongue out, an action of crouching down, an action or walking or running, and an action of lying back while showing a stomach.

The content provider may generate, as the action information, an action that is unable to be performed by the object. For example, the content provider may generate, as the action information, an action of crawling a wall like a lizard, despite that the object is the puppy.

The action information may be information indicating a unique habit of the object. For example, the content provider may generate, as the action information, an action of the object habitually tilting the head.

When the user selects one piece of the standard object content pre-stored in the electronic device 100 or generates new standard object content by correcting selected standard object content, the user may also select an action to be performed by the selected or generated standard object content, or newly generate action information by enabling the standard object content to perform a certain action.

According to an embodiment, the electronic device 100 may control the movement of the standard object content, according to the action information.

According to an embodiment, the electronic device 100 may control the projection object content to move differently according to the projection space.

According to an embodiment, the modeling information corresponding to the projection space may include the projection space structure information. According to an embodiment, the projection space structure information may include information about an arrangement or location of a structure in the projection space and/or space change information according to the arrangement or location of the structure in the projection space.

According to an embodiment, the electronic device 100 may determine the action of the projection object content to be an action corresponding to the projection space structure information. For example, when the projection object content is near a sofa, the electronic device 100 may control the projection object content to sit on the sofa. Alternatively, when the projection object content is near a bed, the electronic device 100 may control the projection object content to perform an action of crawling down under the bed or on the bed.

According to an embodiment, when there is a structure in the projection space, the electronic device 100 may determine a moving direction or action of the projection object content such that the projection object content does not collide with the structure. For example, when there is a refrigerator in the projection space, the electronic device 100 may control the projection object content to walk around the refrigerator.

According to an embodiment, the electronic device 100 may control the action of the projection object content differently according to a degree of a space change. According to an embodiment, the electronic device 100 may control the action of the projection object content differently in the projection space in which the space change is equal to or less than a threshold value and in the projection space in which the space change is greater than the threshold value.

According to an embodiment, the projection space in which the space change is equal to or greater than the threshold value may denote a space changed by a certain size in at least one of the x-axis, the y-axis, or the z-axis.

According to an embodiment, the electronic device 100 may control the action of the projection object content to a first action, in the projection space in which the space change is equal to or less than the threshold value. For example, in a general projection space, the electronic device 100 may control the projection object content to move according to a first movement method.

According to an embodiment, the electronic device 100 may determine the action of the projection object content to a second action different from the first action, in the projection space in which the space change is greater than the threshold value. Unlike the first action, the second action may be a certain movement method that may be performed by the projection object content in a space with a large change.

For example, when the object content/the projection object content is the puppy as shown in FIG. 1, the first action may be an action of crawling around, stretching, crouching, or wagging a tail. Also, the second action may be an action of jumping up, jumping down, or jumping.
As such, according to an embodiment, the electronic device 100 may correct the shape of the projection object content, based on the modeling information corresponding to the projection space.

According to an embodiment, the electronic device 100 may determine the action of the projection object content, based on the modeling information corresponding to the projection space. Accordingly, the user may experience augmented reality in which the virtual image is overlapped on the real world as if the virtual image actually exists.

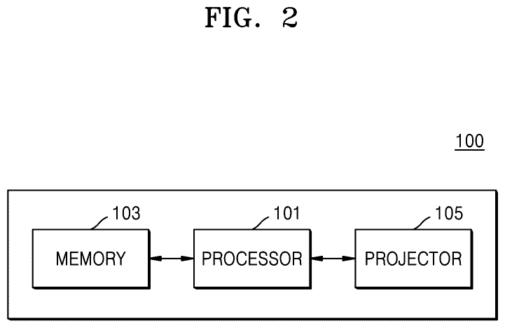

FIG. 2 is a block diagram illustrating an example configuration of the electronic device 100 according to various embodiments.

Referring to FIG. 2, the electronic device 100 may include a processor (e.g., including processing circuitry) 101, a memory 103, and a projector 105.

According to an embodiment, the memory 103 may store at least one instruction. The memory 103 may store at least one program executed by the processor 101. The memory 103 may store data input to or output from the electronic device 100.

The memory 103 may include at least one type of storage medium among a flash memory type, a hard disk type, a multimedia card micro type, a card type memory (for example, a secure digital (SD) or an extreme digital (XD) memory), a random access memory (RAM), a static RAM (SRAM), a read-only memory (ROM), an electrically erasable programmable ROM (EEPROM), a programmable ROM (PROM), a magnetic memory, a magnetic disk, and an optical disk.

According to an embodiment, the memory 103 may store one or more instructions for obtaining the modeling information about the surrounding space.

According to an embodiment, the memory 103 may store one or more instructions for obtaining the modeling information about the surrounding space, based on the surrounding space image and the surrounding space depth information.

According to an embodiment, the memory 103 may store one or more instructions for identifying the direction the user face faces, based on the user feature point, and identifying the space located in the direction the user face faces as the projection space.

According to an embodiment, the memory 103 may store one or more instructions for obtaining the modeling information corresponding to the projection space from the modeling information about the surrounding space.

According to an embodiment, the memory 103 may store one or more instructions for obtaining the standard object content.

According to an embodiment, the memory 103 may store various types of standard object content and action information of the standard object content.

According to an embodiment, the memory 103 may store one or more instructions for recognizing an object from an input image, and generating the standard object content for the recognized object and the action information of the standard object content.

According to an embodiment, the memory 103 may store one or more instructions for correcting the object content/the projection object content, based on the modeling information corresponding to the projection space.

According to an embodiment, the memory 103 may store one or more instructions for correct at least one of a color, brightness, shape, or size of the projection object content, based on the modeling information corresponding to the projection space.

According to an embodiment, the memory 103 may store one or more instructions for correcting a size of the projection object content, using the projection space depth information and the user depth information.

According to an embodiment, the memory 103 may store one or more instructions for determining the action of the projection object content as an action corresponding to the projection space structure information.

According to an embodiment, the memory 103 may store one or more instructions for determining the action of the projection object content as the first action, in the projection space in which the space change is equal to or less than the threshold value.

According to an embodiment, the memory 103 may store one or more instructions for determining the action of the projection object content as the second action different from the first action, in the projection space in which the space change is greater than the threshold value.

According to an embodiment, the memory 103 may store one or more instructions for determining at least one of a color or brightness of the background content, based on at least one of a color or brightness of the modeling information corresponding to the projection space.

According to an embodiment, the memory 103 may store one or more instructions for determining the brightness of the background content to a minimum value.

According to an embodiment, the memory 103 may store one or more instructions for projecting, onto the projection space, the projection content including the projection object content and the background content.

According to an embodiment, the memory 103 may store one or more instructions for controlling movement of the object content, based on at least one of a pre-set period, a random period, or event occurrence.

The processor 101 according to an embodiment may control overall operations of the electronic device 100 and a signal flow between internal components of the electronic device 100, and perform a function of processing data.

According to an embodiment, the processor 101 may include various processing circuitry and execute the one or more instructions stored in the memory 103 to control the electronic device 100 to operate.

According to an embodiment, the processor 101 may include a single core, a dual core, a triple core, a quad core, or a multiple core.

According to an embodiment, there may be one or a plurality of the processors 101. Also, the processor 101 may include a plurality of processors. In this case, the processor 101 may be implemented by a main processor and a sub processor.

The processor 101 may include at least one of a central processing unit (CPU), a graphics processing unit (GPU), or a video processing unit (VPU). Alternatively, according to an embodiment, the processor 101 may be implemented in the form of a system-on-chip (SoC) in which at least one of CPU, GPU, or VPU is integrated. Alternatively, according to an embodiment, the processor 101 may further include a neural processing unit (NPU). The processor 101 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the at least one processor 101 may execute the one or more instructions to obtain the modeling information corresponding to the projection space from the modeling information about the surrounding space.

According to an embodiment, the processor 101 may obtain the projection object content by correcting the standard object content, based on the modeling information corresponding to the projection space.

According to an embodiment, the processor 101 may determine the action of the projection object content, based on the modeling information corresponding to the projection space.

According to an embodiment, the processor 101 may project, onto the projection space, the projection content including the projection object content performing the determined action, by controlling the projector 105.

According to an embodiment, the at least one processor 101 may execute the one or more instructions to determine the action of the projection object content as the action corresponding to the projection space structure information.

According to an embodiment, the at least one processor 101 may execute the one or more instructions to determine the action of the projection object content as the first action, in the projection space in which the space change is equal to or less than the threshold value.

According to an embodiment, the processor 101 may determine the action of the projection object content to the second action different from the first action, in the projection space in which the space change is greater than the threshold value.

According to an embodiment, the at least one processor 101 may execute the one or more instructions to determine the action of the projection object content, based on at least one of the pre-set period, the random period, or the event occurrence.

According to an embodiment, the at least one processor 101 may execute the one or more instructions to correct at least one of the color, brightness, form, or size of the standard object content, based on the modeling information corresponding to the projection space.

According to an embodiment, the modeling information corresponding to the projection space may include the projection space depth information.

According to an embodiment, the processor 101 may obtain the user depth information. According to an embodiment, the processor 101 may correct the size of the standard object content using the projection space depth information and the user depth information.

According to an embodiment, the electronic device 100 may rotate based on at least one of the x-axis, the y-axis, or the z-axis.

According to an embodiment, the at least one processor 101 may execute the one or more instructions to obtain the surrounding space image and the surrounding space depth information.

According to an embodiment, the processor 101 may obtain modeling information about the surrounding space, based on the surrounding space image and the surrounding space depth information.

According to an embodiment, the modeling information about the surrounding space may include the color information and depth information according to the rotating angle for each axis of the electronic device 100.

According to an embodiment, the processor 101 may obtain the user image and identify the user feature point from the user image.

According to an embodiment, the processor 101 may identify the direction the user face faces, based on the user feature point. According to an embodiment, the processor 101 may identify the space located in the direction the user face faces, as the projection space.

According to an embodiment, the projection content may further include the background content.

According to an embodiment, the at least one processor 101 may execute the one or more instructions to determine at least one of a color or brightness of the background content, based on at least one of a color or brightness of the modeling information corresponding to the projection space.

According to an embodiment, the processor 101 may determine the brightness of the background content to the minimum value.

The projector 105 according to an embodiment is a component configured to externally project light for representing an image, and may also be referred to as a projection unit. The projector 105 may include various detailed components, such as a light source, a projection lens, and a reflector.

The projector 105 may project an image in various projection methods, for example, a cathode-ray tube (CRT) method, a liquid crystal display (LCD) method, a digital light processing (DLP) method, and a laser method.

The projector 105 may include various types of light sources. For example, the projector 105 may include at least one light source from among a lamp, a light-emitting diode (LED), and a laser.

The projector 105 may output the image in a 4:3 aspect ratio, a 5:4 aspect ratio, or a 16:9 wide aspect ratio, according to the purpose of the electronic device 100 or user setting, and may output an image in various types of resolution, such as WVGA (854*480), SVGA (800*600), XGA (1024*768), WXGA (1180*720), WXGA (1180*800), SXGA (1180*1024), UXGA (1600*1100), full HD (1920*1080), according to an aspect ratio.

The projector 105 may perform various functions for adjusting an output image, according to control by the processor 101. For example, the projector 105 may perform functions, such as zoom, keystone, and lens shift.

The projector 105 may perform a zoom function, a keystone compensation function, and a focus adjustment function, by analyzing a surrounding environment and a projection environment according to control by the user or automatically without the control by the user.

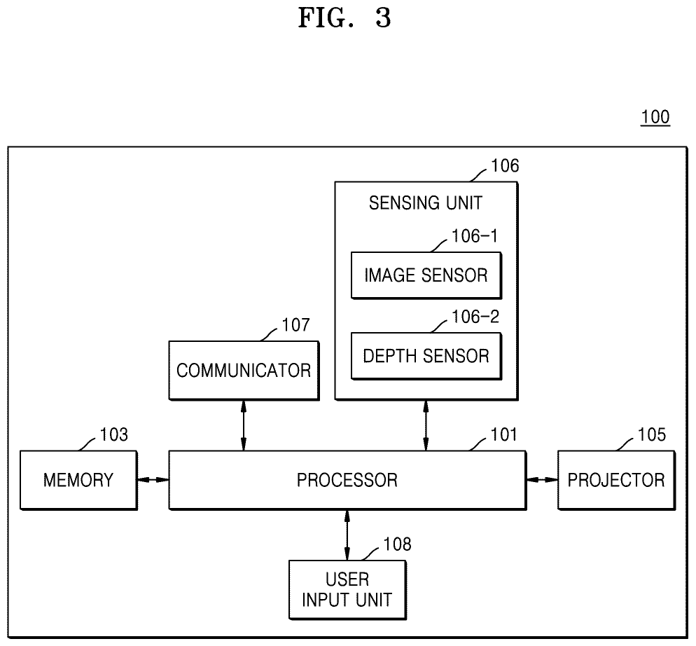

FIG. 3 is a block diagram illustrating an example configuration of the electronic device 100 according to an embodiment.

Referring to FIG. 3, according to an embodiment, the electronic device 100 may further include a sensing unit (e.g., including at least one sensor) 106, a communicator (e.g., including communication circuitry) 107, and a user input unit (e.g., including user input circuitry) 108, in addition to the processor 101, the memory 103, and the projector 105.

According to an embodiment, the sensing unit 106 may include at least one sensor. The senor may obtain raw data by detecting a state of the electronic device 100 or a state around the electronic device 100, and transmit the raw data to the processor 101.

According to an embodiment, the sensing unit 106 may include an image sensor 106-1. According to an embodiment, the image sensor 106-1 may include a camera. The image sensor 106-1 may include a lens and a sensor, such as a charge-coupled device (CCD) or a complementary metal-oxide semiconductor (CMOS), and may obtain an image formed on a screen by photographing a subject. The image sensor 106-1 may convert information about the subject formed by light into an electric signal. Also, the image sensor 106-1 may perform, on the captured image, one or more signal processes from among auto exposure (AE), auto white balance (AWB), color recovery, correction sharpening, gamma, and lens shading correction.

According to an embodiment, the sensing unit 106 may include a depth sensor 106-2. The depth sensor 106-2 according to an embodiment may calculate a distance between the camera and the subject using a time taken for the light emitted towards the subject to return after being reflected at the subject, and obtain information about a space where the subject is located. According to an embodiment, the depth sensor 106-2 may recognize 3-dimensional (3D) depth in one of a stereo type method, a time-of-flight (ToF) method, and a structured pattern method.

In FIG. 3, the depth sensor 106-2 is included in the electronic device 100 as a module or block separated from the image sensor 106-1, but is not limited thereto, and the depth sensor 106-2 may be included in the image sensor 106-1. For example, the depth sensor 106-2 may be included in a camera having a depth function from among cameras, and obtain the distance to the subject when the image of the subject is obtained.

The sensing unit 106 may further include an acceleration sensor and/or a position sensor (e.g., a global positioning system (GPS)), in addition to the image sensor 106-1 and the depth sensor 106-2. The acceleration sensor and the position sensor may obtain raw data for estimating the rotating angle of the electronic device 100. According to an embodiment, the processor 101 may estimate the rotating angle of the electronic device 100 with respect to three axes, e.g., the x-axis, the y-axis, and the z-axis, based on the raw data obtained through the sensing unit 106.

The communicator 107 according to an embodiment may include a component, including various communication circuitry, for performing communication with another device. For example, the communicator 107 may include a short-range wireless communicator and a mobile communicator.

According to an embodiment, the short-range wireless communicator may include a Bluetooth communicator, a Bluetooth low energy (BLE) communicator, a near field communicator, a wireless local area network (WLAN) (Wi-Fi) communicator, a Zigbee communicator, an infrared data association (IrDA) communicator, a Wi-Fi direct (WFD) communicator, an ultra-wideband (UWB) communicator, or an Ant+ communicator, but is not limited thereto.

According to an embodiment, the BLE communicator may transmit a BLE signal always, periodically, at random time intervals, or at pre-set time points.

According to an embodiment, the mobile communicator may transmit and/or receive a wireless signal to or from at least one of a base station, an external terminal, or a server, on a mobile communication network. Here, the wireless signal may include various types of data according to exchange of a voice call signal, an image call signal, or a text/multimedia message.

According to an embodiment, the communicator 107 may receive, from the external server, the standard object content and the action information. The action information of the standard object content may be information indicating various types of actions that may be performed by the standard object content.

The user input unit 108 according to an embodiment may include various user input circuitry and receive a user input for controlling the electronic device 100. The user input unit 108 may include various types of user input devices including a touch panel for detecting the user's touch, a touchpad (a contact capacitance type, a pressure resistive type, an infrared detection type, a surface ultrasonic conduction type, an integral tension measurement type, or a piezo-effect type), a button receiving a push manipulation of the user, a jog wheel receiving a rotation manipulation of the user, a jog switch, a keyboard, a keypad, a dome switch, a microphone for voice recognition, and a motion detection sensor sensing motion, but is not limited thereto. Also, when the electronic device 100 is manipulated by a remote controller (not shown), the user input unit 108 may receive a control signal received from the remote controller.

According to an embodiment, the user input unit 108 may receive a control signal from the user. The user may input the control signal for projecting object content using the user input unit 108. The control signal for projecting the object content may be realized in various cases, such as a case where the user enters near a space where the electronic device 100 is located, a case where the user takes certain motion, and a case where the user invokes the object content in voice.

The user may input the projection object content action control signal for controlling an action of the object content. According to an embodiment, the user may input the projection object content action control signal to the electronic device 100 using a method of taking a certain gesture or uttering a certain word. For example, when the user performs a certain action, such as an action of waving the hand from side to side, the electronic device 100 may receive such motion of the user as a control signal for controlling an action of the projection object content. When the user utters a speech instruction for performing a certain action, such as “jump!” or “give me paw”, the electronic device 100 may receive the speech instruction as the control signal for controlling the action of the object content. The electronic device 100 may control the projection object content to perform a certain action in response to the control signal according to the motion or speech utterance of the user.

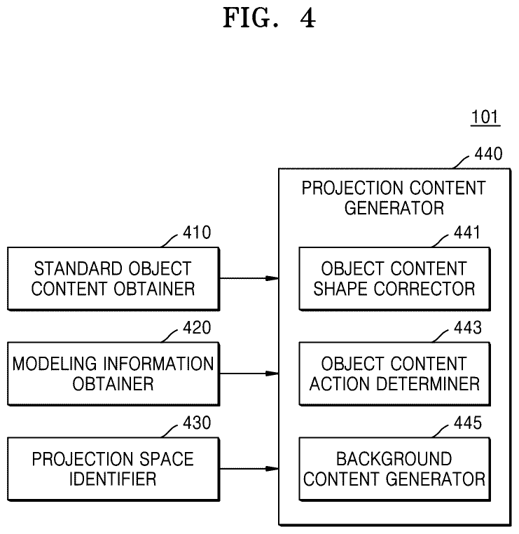

FIG. 4 is a block diagram illustrating an example configuration of an operating module of the processor 101 inside the electronic device 100, according to various embodiments.

Referring to FIG. 4, the processor 101 may include a standard object content obtainer 410, a modeling information obtainer 420, a projection space identifier 430, and a projection content generator 440, each of which may include various circuitry and/or executable program instructions.

According to an embodiment, the electronic device 100 may output various types of content provided by content providers. The content may include a still image, a video such as a moving image, audio, a subtitle, and other additional information. The content provider may be a content manufacturer who provides various types of content to a consumer. Examples of the content provider may include an Internet protocol television (IPTV) service provider, an over-the-top (OTT) service provider, a terrestrial broadcasting station, a cable broadcasting station, and a satellite broadcasting station.

According to an embodiment, the electronic device 100 may receive various types of content generated by the content provider through an external device or external server, and output the same. For example, the external device may be implemented as any type of source device, such as a personal computer (PC), a set top box, a Blu-ray disc player, a mobile phone, a game device, a home theater, an audio player, or a universal serial bus (USB).

According to an embodiment, the standard object content obtainer 410 may receive the standard object content provided by the content provider, from the external device or external server.

When the memory 103 of the electronic device 100 stores pre-generated standard object content and the user selects one piece of the pre-generated standard object content, the standard object content obtainer 410 may obtain the standard object content pre-stored in the memory 103, based on user selection.

The user may directly generate the standard object content using the electronic device 100. For example, the user may directly draw an image of character or avatar in a certain form having a certain size or color using the electronic device 100 or may obtain an image by photographing a person or object and input the image into the electronic device 100, such that the electronic device 100 may generate the standard object content from the image.

The user may partially modify the standard object content pre-stored in the memory 103 of the electronic device 100 into a desired form, and use the same as the standard object content.

According to an embodiment, the standard object content obtainer 410 may transmit, to the projection content generator 440, the standard object content obtained from the external device, the external server, or the memory 103 of the electronic device 100, or obtained from the image input by the user.

According to an embodiment, the modeling information obtainer 420 may obtain the modeling information about the surrounding space.

According to an embodiment, the electronic device 100 may obtain the surrounding space image through the image sensor 106-1. According to an embodiment, the electronic device 100 is rotatable in a certain angle or greater in each of x-, y-, and z-axes, and thus the image sensor 106-1 mounted on the electronic device 100 also rotates with the electronic device 100 to obtain images of the surrounding space in a plurality of angles.

According to an embodiment, the electronic device 100 may obtain the surrounding space depth information through the depth sensor 106-2. According to an embodiment, the surrounding space depth information may denote distance information to an environment or structure of the surrounding space.

According to an embodiment, the modeling information obtainer 420 may obtain the modeling information about the surrounding space, based on the surrounding space image obtained through the image sensor 106-1 and the surrounding space depth information obtained through the depth sensor 106-2.

According to an embodiment, the modeling information obtainer 420 may model the shape of the surrounding space by connecting the environment of the surrounding space, surfaces or locations of objects arranged in the surrounding space, and geometric information using dots, lines, or surfaces. According to an embodiment, the modeling information obtainer 420 may perform rendering on the plurality of lines or dots generated for the objects or environment of the surrounding space, such that the objects or environment have colors, volume, and texture similar to the actual environment or actual objects.

According to an embodiment, the modeling information about the surrounding space may include the color information and depth information according to the rotating angle for each axis of the electronic device 100.

According to an embodiment, the modeling information obtainer 420 may transmit the modeling information about the surrounding space to the projection content generator 440.

According to an embodiment, the projection space identifier 430 may identify the projection space. According to an embodiment, the projection space identifier 430 may detect the user feature point from the user image. The user feature point may be information for identifying a body part of the user, such as the head, ear, neck, shoulder, or face of the user.

According to an embodiment, the projection space identifier 430 may generate a figure by modeling the user's body by connecting the user feature points detected from the image. For example, the projection space identifier 430 may generate a hexahedral figure including the back of the user's head in the center and the both ears of the user at the ends of the figure. According to an embodiment, the projection space identifier 430 may identify the direction the face of the user faces, based on the figure obtained by modeling the user's body. According to an embodiment, the projection space identifier 430 may identify how much the figure obtained by modeling the user's body is tilted in which axis, and accordingly, identify how much the direction the face of the user faces is tilted in which axis.

According to an embodiment, the projection space identifier 430 may identify the space located in the direction the face of the user faces, as the projection space. According to an embodiment, the projection space may be displayed in a range of the rotating angle for each axis of the electronic device 100. Alternatively, according to an embodiment, the projection space may be displayed in a range of a unique coordinate value of the identified projection space.

According to an embodiment, the projection space identifier 430 may transmit the information indicating the projection space to the projection content generator 440.

According to an embodiment, the projection content generator 440 may generate the projection content to be projected through the projector 105. According to an embodiment, the projection content generator 440 may identify the modeling information corresponding to the projection space received from the projection space identifier 430, among modeling information about the surrounding environment received from the modeling information obtainer 420.

According to an embodiment, the projection content generator 440 may include an object content shape corrector 441, an object content action determiner 443, and a background content generator 445, each of which may include various circuitry and/or executable program instructions.

According to an embodiment, the object content shape corrector 441 may correct the shape of the standard object content received from the standard object content obtainer 410, based on the modeling information corresponding to the projection space. According to an embodiment, the object content shape corrector 441 may correct the shape of the standard object content, such as the color, brightness, form, and size of the standard object content, based on the modeling information corresponding to the projection space.

According to an embodiment, the object content shape corrector 441 may independently correct the color, brightness, form, and size for each of a plurality of sub areas configuring the standard object content. According to an embodiment, the object content shape corrector 441 may divide the standard object content into the plurality of sub areas, based on the modeling information corresponding to the projection space. For example, the object content shape corrector 441 may divide the standard object content into the plurality of sub areas, for each of areas distinguished by colors in the projection space, and correct the sub areas differently according to the colors of the projection space.

When there is an area darker than the surroundings in the projection space, an area of the projection object content projected onto the dark projection space may be displayed relatively dark compared to other areas of the projection object content. When there is an area brighter than the surroundings in the projection space, an area of the projection object content projected onto the bright projection space may be displayed relatively bright compared to other areas of the projection object content. In other words, when there are the dark area and the bright area together in the projection space, a portion of the object content may be bright and another portion of the object content may be dark depending on brightness of the projection space even when the object content of same brightness is projected.

Similarly, even for the same object content, the color or brightness of the object content may vary depending on the color of the projection space, due to a phenomenon, such as color contrast.

Even for the same object content, sizes or forms of objects may be distorted according to the depth information of the projection space. For example, when the projection space includes a protruding plane, an area of the object content projected onto the protruding plane may look bigger than an area of the object content projected onto a plane that does not protrude.

When the projection space is not an even plane but is uneven, the form of the object content projected onto an uneven space may look distorted.

In this regard, according to an embodiment, the object content shape corrector 441 may differently correct the areas of the standard object content, based on the modeling information about the projection space, so as to prevent or avoid portions configuring one piece of object content from looking distorted as having different colors, brightnesses, sizes, and forms, according to different brightnesses, colors, depth information of the projection space.

According to an embodiment, the object content shape corrector 441 may differently adjust the colors, brightnesses, forms, and sizes of the standard object content according to each pixel.

According to an embodiment, the object content shape corrector 441 may differently correct the colors, brightnesses, shapes, and sizes, according to the plurality of sub areas, such that the entire color, brightness, shape, and size of the corrected projection object content look as having a unified color, brightness, size, and shape.

According to an embodiment, the object content action determiner 443 may determine the action of the projection object content. According to an embodiment, the object content action determiner 443 may determine the action of the projection object content, based on the modeling information corresponding to the projection space. According to an embodiment, the modeling information corresponding to the projection space may include the projection space structure information.

According to an embodiment, the object content action determiner 443 may determine the action of the projection object content as the action corresponding to the projection space structure information.

According to an embodiment, the projection space structure information may include the space change information.

According to an embodiment, the object content action determiner 443 may determine the action of the projection object content as the first action in the projection space in which the space change is equal to or less than the threshold value, and determine the action of the projection object content as the second action different from the first action in the projection space in which the space change is greater than the threshold value.

For example, the object content action determiner 443 may control the projection object content to perform different actions in an area having a depth value difference equal to or greater than a threshold value and in an area having a depth value difference less than the threshold value, based on the depth value difference of the projection space.

According to an embodiment, when generating the standard object content, the content provider may determine the color, design, size, and type of the standard object content while also determining a type of the action performable by the standard object content, e.g., the action information. For example, when the standard object content is a ladybug, the content provider may determine an action of the ladybug crawling as the action performable by the standard object content. The content provider may pre-determine the action performable by the standard object content, in an area in which the depth value difference of the projection space is greater than the threshold value. For example, in the above example, the content provider may determine the ladybug to perform an action of spreading wings and flying when the ladybug is moving in the area in which the depth value difference is greater than the threshold value.

According to an embodiment, the object content action determiner 443 may determine the action of the object content using the action information about pre-determined actions performable by the standard object content.

According to an embodiment, the background content generator 445 may generate the background content. According to an embodiment, the background content may denote a remaining area of the projection content excluding the projection object content. According to an embodiment, the background content generator 445 may identify the modeling information corresponding to the projection space received from the projection space identifier 430, among the modeling information about the surrounding environment received from the modeling information obtainer 420.

According to an embodiment, the background content generator 445 may generate the background content, based on the modeling information corresponding to the projection space. According to an embodiment, the background content generator 445 may determine at least one of the color or brightness of the background content, based on at least one of the color or brightness of the modeling information corresponding to the projection space. For example, the background content generator 445 may generate the background content in the same color and brightness as the projection space. In this case, because the background content is projected in the color and brightness similar to the actual space, the user is unable to distinguish between the background content and the actual space even when the background content is projected.

According to an embodiment, the background content generator 445 may determine the brightness of the background content to the minimum value. When the background content is projected in the minimum brightness, the background content is not well identified, and thus there may be an effect as if only the projection object content is projected.

According to an embodiment, the projection content generator 440 may generate the projection content including the object content having the corrected shape, e.g., the projection object content, generated by the object content shape corrector 441, and the background content generated by the background content generator 445, and project the projection content onto the projection space.

According to an embodiment, the projection object content included in the projection content may perform the action determined by the object content action determiner 443.

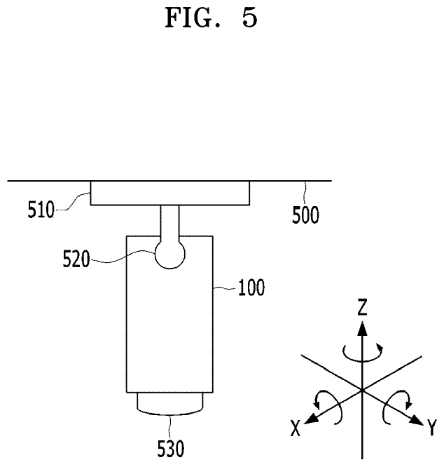

FIG. 5 is a diagram illustrating the electronic device 100 being rotated, according to various embodiments.

Referring to FIG. 5, the electronic device 100 may be mounted on a fixed surface 500, such as a wall, a ceiling, or a stand. According to an embodiment, the electronic device 100 may be mounted on the fixed surface 500 through a support 510. The support 510 may be a component used to fix the electronic device 100 to a certain location. According to an embodiment, the support 510 may be connected to a bracket 520. The bracket 520 may also be referred to as a mount. The bracket 520 may be a component connecting the support 510 and the electronic device 100 to each other. According to an embodiment, the electronic device 100 may be rotatably connected to the bracket 520.

According to an embodiment, a projector 530 may be provided at one end of the electronic device 100.

Referring to FIG. 5, when it is assumed that the projector 530 includes a projection surface orthogonal to a projection direction of projecting the projection content, the projection direction of light projected perpendicular to the projection surface or a direction opposite to the projection direction may be defined as the z-axis. A direction perpendicular to the z-axis and parallel to the projection surface may be defined as the y-axis and a direction orthogonal to the z-axis and y-axis and parallel to the projection surface may be defined as the x-axis.

According to an embodiment, the electronic device 100 may rotate according to each axis. For example, the electronic device 100 may rotate up to 180° in the x-axis and y-axis parallel to the fixed surface 500. Also, according to an embodiment, the electronic device 100 may rotate up to 360° in the z-axis.

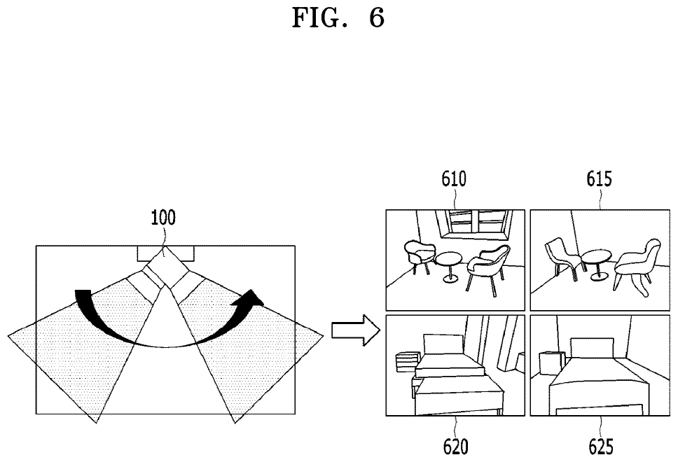

FIG. 6 is a diagram illustrating the electronic device 100 obtaining the modeling information about the surroundings, according to various embodiments.

Referring to FIG. 6, the electronic device 100 may rotate by being rotatably arranged at a wall or ceiling. However, this is only an example and the electronic device 100 may be arranged on a floor, and may be movable instead of being fixed to a certain location.

According to an embodiment, when the electronic device 100 may rotate according to each axis, the image sensor 106-1 and the depth sensor 106-2 included in the electronic device 100 also rotate according to the axis.

According to an embodiment, the electronic device 100 may obtain an image about the surroundings by photographing the surrounding environment or object using the image sensor 106-1 included in the electronic device 100.

According to an embodiment, the electronic device 100 may obtain depth information to the surrounding environment or object using the depth sensor 106-2 included in the electronic device 100.

According to an embodiment, the electronic device 100 may model the surrounding space using the image about the surroundings and the depth information about the surroundings.

As shown in FIG. 6, the electronic device 100 may obtain modeling information 615 and 625 about the surrounding space by modeling actual surrounding spaces 610 and 620.

According to an embodiment, the electronic device 100 may model the surrounding space using various methods. According to an embodiment, the electronic device 100 may represent a shape of the surrounding space in basic geometric elements, such as dots, straight lines, circles, and arcs, using a wireframe modeling method that is a method of representing a 3D structure in lines. The wireframe modeling method is a method of representing a shape in wireframes and end points of an object, and a shape of a model may be modified by modifying lines and dots. According to an embodiment, the electronic device 100 may generate a realistic image by modeling the surrounding space using the wireframe modeling method and performing a rending operation of coloring surfaces formed as lines meet.

According to an embodiment, the electronic device 100 may represent a 3D structure in surfaces using a surface modeling method. The surface modeling method is a method enabling representation of complicated curved surfaces by adding information about surfaces to the wireframe modeling method. Such a modeling method is a method of disassembling a 3D object into components of 2D surfaces, and a 3D shape may be generated by combining a plurality of surfaces. According to such a method, only surface data is obtained without information about the inside of the object. Because the information about the inside of the object is not considered, a computing speed may be increased and the use of memory capacity may be decreased.

According to an embodiment, the electronic device 100 may obtain coordinates of dots configuring the surrounding space, a list of curve equations representing lines, a list of curved surface equations, and correlation information between dots, lines, and curved surfaces, and model the surrounding space using the surface modeling method, based thereon.

According to an embodiment, the electronic device 100 may model a space using a polygon modeling method that is one of the surface modeling methods. The polygon modeling method is a method of generating a stereoscopic form by combining lines (edges) in which dots (vertexes) are connected, and surfaces (faces) in which the lines are connected, using the dots as base units. According to the polygon modeling method, a plurality of polygons may be assembled to form one character or object. However, the present disclosure is not limited thereto, and the electronic device 100 may obtain the modeling information about the surrounding space using, for example, a non-uniform rotational B-spline modeling (Nurbs) method among the surface modeling methods or using a subdivision surface modeling method.

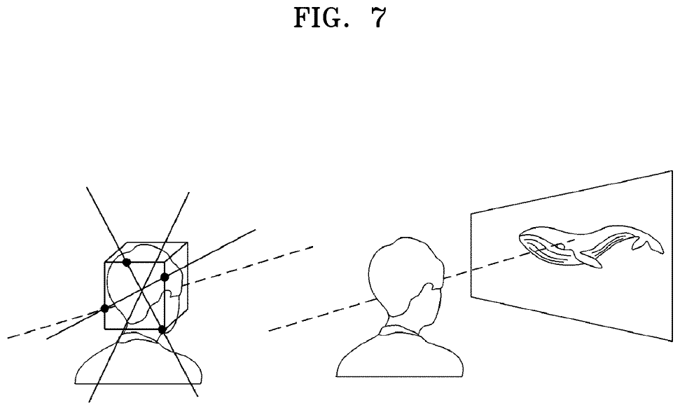

FIG. 7 is a diagram illustrating the electronic device 100 identifying the projection direction, according to various embodiments.

According to an embodiment, the electronic device 100 may photograph the user using the image sensor 106-1. For example, when the user is looking at an opposite direction of the electronic device 100 instead of looking at the electronic device 100, the image sensor 106-1 may obtain the user image by photographing the user from the back of the user. Here, the obtained user image may include the back of the head of the user, the back of the both ears of the user, the back of the neck of the user, and the shoulder of the user.

According to an embodiment, the electronic device 100 may analyze the user image obtained by photographing the user. According to an embodiment, the electronic device 100 may detect the user feature point from the user image. The user feature point may be a key point for each part for identifying the body part.

According to an embodiment, the electronic device 100 may connect the identified user feature points and generate a figure in which the user feature points are connected. The figure in which the user feature points are connected may be a 2D plane figure or a 3D figure.

In FIG. 7, a hexahedral figure generated by the electronic device 100 by connecting the user feature points detected from the user image is illustrated. However, this is only an embodiment, and the electronic device 100 may generate various forms of figures, based on the user feature points.

According to an embodiment, the electronic device 100 may identify a degree the figure generated by connecting the user feature points is tilted. When the user image is obtained while the user is looking straight ahead, a stereoscopic figure generated by connecting the user feature points may be a reference figure that is erected without being tilted.

When the user is not looking straight ahead, but the head is tilted left or right, or the face is lifted to look at the ceiling, the stereoscopic figure generated by connecting the user feature points may be tilted in any one direction unlike the reference figure.

According to an embodiment, the electronic device 100 may compare the stereoscopic figure generated by connecting the user feature points with the reference figure, and identify a direction the front of the stereoscopic figure faces and a direction the stereoscopic figure is tilted. According to an embodiment, the electronic device 100 may identify a face direction of the user according to the direction the stereoscopic figure is tilted.

According to an embodiment, the electronic device 100 may identify the direction the face of the user faces as the projection direction, and identify the space located in the direction the face of the user faces as the projection space.

According to an embodiment, the electronic device 100 may project the projection content onto the projection space located in the direction the face of the user faces.

According to an embodiment, the electronic device 100 may identify the projection direction again when the direction the user is looking is changed by the threshold value or greater. For example, when the user turns the head and looks at a second wall facing a first wall while looking at the first wall in a space, the electronic device 100 may obtain a new user image and identify the direction the face of the user faces, based on the user feature points obtained from the new user image.

According to an embodiment, the electronic device 100 may identify a space located in the second wall the face of the user faces, as a new projection space. The electronic device 100 may control the projection object content to act in a pre-defined order, when the projection space is changed. For example, when the projection object content is a whale, the electronic device 100 may control the whale to spout water in the new projection space.

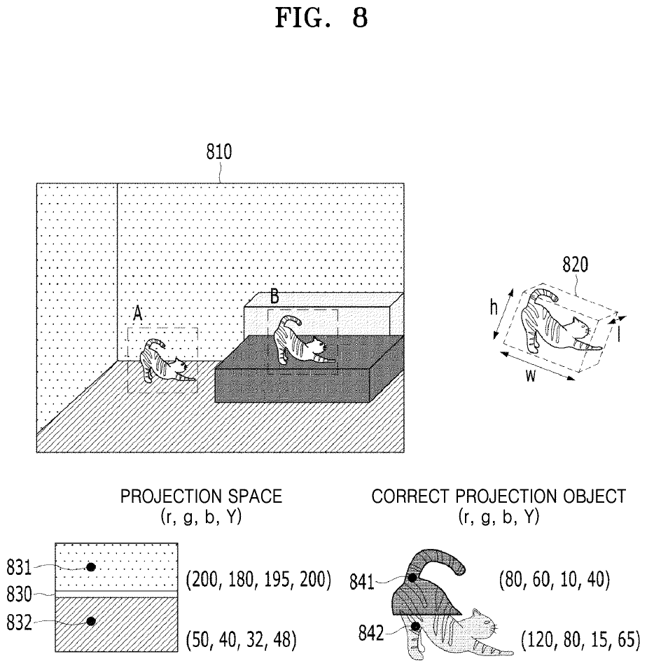

FIG. 8 is a diagram illustrating the electronic device 100 correcting the shape of the object content, based on the modeling information corresponding to the projection space, according to various embodiments.

According to an embodiment, the electronic device 100 may obtain the modeling information about the surrounding space. According to an embodiment, the electronic device 100 may identify the direction the face of the user faces, and identify the space located in the direction the face of the user faces as the projection space.

According to an embodiment, the electronic device 100 may identify the modeling information corresponding to the projection space that is the space the face of the user faces, among the modeling information about the surrounding space.

A reference numeral 810 of FIG. 8 indicates a figure in which the projection object content is projected onto the projection space. FIG. 8 illustrates an example in which the projection object content is a cat. According to an embodiment, the electronic device 100 may obtain the standard object content having a shape of a cat. According to an embodiment, the standard object content may be represented as a 3D shape having a width, a height, and a length, as indicated by a reference numeral 820. Also, the standard object content may be represented as having the color information and luminance information for each pixel.

According to an embodiment, the modeling information corresponding to the projection space may include the color information and luminance information according to the rotating angle for each axis of the electronic device 100. For example, when two projection points included in one area indicated by A in the projection space of the reference numeral 810 are respectively a first point 831 and a second point 832, the first point 831 and the second point 832 may be each represented by color information (r, g, b) and luminance information (Y), as indicated by a reference numeral 830. In the first point 831, (r, g, b, Y) may be represented as (200, 180, 195, 200) and in the second point 832, (r, g, b, Y) may be represented as (50, 40, 32, 48).

It is determined that, among the projection points, the first point 831 has a color close to white and is bright, whereas the second point 832 has darker color and luminance unlike the first point 831.

According to an embodiment, the electronic device 100 may identify a corresponding point of the standard object content projected onto the projection point in the projection space. For example, the electronic device 100 may identify a first point 841 and a second point 842, which are corresponding points of the standard object content projected onto the first point 831 and the second point 832 that are the projection points, respectively.

According to an embodiment, the standard object content is content generated based on a case where the depth information, luminance, or color of the projection space has a standard value, and thus when the space structure, color, or brightness of the projection space does not have the standard value, the size, shape, color, or brightness of the standard object content projected onto such a projection space may be different from the standard object content.

According to an embodiment, when the color and luminance of the projection space onto which the standard object content is projected are standard color and standard luminance, the electronic device 100 may project the standard object content without correcting the color or luminance of the standard object content. However, when the color or luminance of the projection space is not the standard color or standard luminance, the electronic device 100 may correct the color or luminance of the standard object content according to the color or luminance of the projection space, such that the projection object content projected onto the projection space has the color or luminance of the standard object content.

When the projection space onto which the standard object content is projected includes an area having a different color or luminance, but the standard object content is projected without the color or luminance of the standard object content being corrected, the projection object content may look as if areas thereof have different colors or luminance due to the different colors or luminance of the projection space, despite that the standard object content projected throughout areas of the projection space having different colors or luminance is one standard object.

For example, in the above example, among the projection points, the first point 831 has a white color and is bright whereas the second point 832 has a dark color and is dark, and thus even when the colors and luminance of the first point 841 and the second point 842 of the standard object content projected onto the first point 831 and the second point 832 are the same, the first point 841 of the standard object content may be represented whiter and brighter than the second point 842 and the second point 842 may be represented in a darker color and darker when the standard object content is projected onto the projection space.

According to an embodiment, the electronic device 100 may correct the color, brightness, form, and size of the projection object content, based on the modeling information corresponding to the projection space. According to an embodiment, the electronic device 100 may generate the projection object content by correcting the color information and luminance information of the corresponding point of the standard object content, which is projected onto the projection point, using the color information and luminance information of the projection point of the projection space.

According to an embodiment, even when the color information and luminance information of the first point 841 and the second point 842 of the standard object content have the same values, the electronic device 100 may correct the color information and luminance information of the corresponding point of the standard object content to different values, according to the color information and luminance information of the projection point.

For example, when it is assumed that the color information and luminance information of the first point 841 and second point 842 of the standard object content have the same values, according to an embodiment, the electronic device 100 may correct the color information and luminance information of the first point 841 of the standard object content projected onto the first point 831 to (80, 60, 10, 40), using the color information and luminance information of the first point 831 that is the projection point. The electronic device 100 may correct the color information and luminance information of the second point 842 of the standard object content projected onto the second point 832 to (120, 80, 15, 65), using the color information and luminance information of the second point 832 that is the projection point.

According to an embodiment, among the projection points, the electronic device 100 may correct the color and luminance of the first point 841 of the standard object content projected onto the first point 831 that has a white color and is bright, to have a darker color and be dark, and correct the color and luminance of the second point 842 of the projection object content projected onto the second point 832 that has a dark color and is dark, to have a brighter color and be bright, such that the first point 841 and the second point 842 of the projection object content projected onto the projection space may be represented as having uniform colors and luminance.

A projection point included in an area indicated by B on the projection space of the reference numeral 810 may be represented by color information (r, g, b) and luminance information (Y). According to an embodiment, it is determined that the area indicated by B have different luminance information in an upper area and a lower area. According to an embodiment, when the standard object content is projected throughout the upper area and the lower area included in the area B, the electronic device 100 may differently correct the luminance information of points of the standard object content, according to the projection points.

According to an embodiment, the electronic device 100 may correct luminance of a point of the projection object content projected onto a brighter point among the projection points to have darker luminance, and correct luminance of a point of the projection object content projected onto a darker point among the projection points to have brighter luminance, such that different points of the projection object content projected onto the projection space may be represented as having the same luminance.

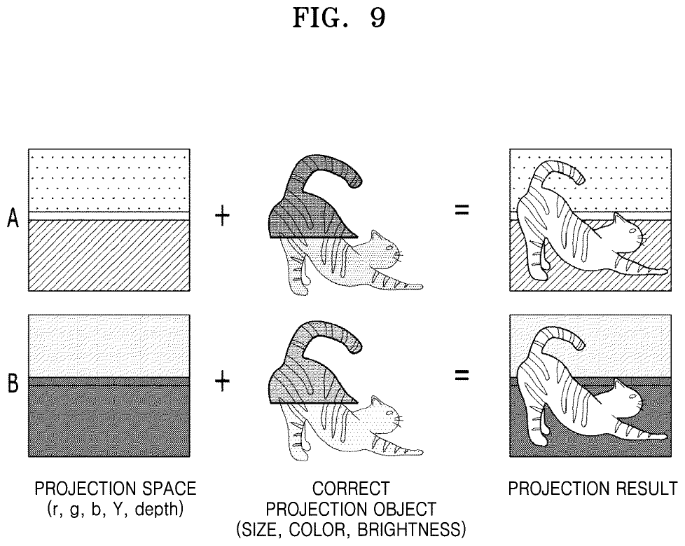

FIG. 9 is a diagram illustrating the electronic device 100 correcting the shape of the object content, based on the modeling information corresponding to the projection space, according to various embodiments.

According to an embodiment, the electronic device 100 may identify the modeling information corresponding to the projection space from among the modeling information about the surrounding space.

According to an embodiment, the modeling information corresponding to the projection space may include the depth information. According to an embodiment, the electronic device 100 may adjust the size of the standard object content by using the depth information of the projection space.

FIG. 9 illustrates the area A and the area B, which are the two areas included in the projection space indicated by the reference numeral 810.

According to an embodiment, points included in the area A and the area B may have different depth values. For example, the area A may include a wall surface area above and a floor surface area below. According to an embodiment, the wall surface area and the floor surface area included in the area A may have different depth values. In other words, because a distance from the electronic device 100 to a wall surface is greater than a distance from the electronic device 100 to a floor surface, the wall surface area has a greater depth value. The floor surface area has a greater depth value towards a boundary point with the wall surface area and has a smaller depth value farther away from the boundary point.

When the standard object content is projected without correcting the size despite that the projection space onto which the standard object content is projected includes areas having different depth values, the areas of the standard object content projected throughout the areas of the projection space, which have different depth values, may be distorted to have different sizes due to the different depth values of the projection space despite that the standard object content is one standard object.

For example, when the standard object content is projected as it is onto the wall surface and the floor surface despite that the depth value of the wall surface of greater than the depth value of the floor surface is smaller, a projection point of the standard object content projected onto the wall surface may be represented as having a smaller value due to a distance to the wall surface.

According to an embodiment, the electronic device 100 may correct the size of the projection object content, based on the modeling information corresponding to the projection space. According to an embodiment, the electronic device 100 may correct a size of a corresponding point of the standard object content, which is projected onto the projection point, using a depth value of the projection point of the projection space.

According to an embodiment, the electronic device 100 may adjust the size of the corresponding point of the standard object content, which is projected onto a point having a great depth value, to be greater, and adjust the size of the corresponding point, which is projected onto a point having a small depth value, to be smaller. In other words, in the above example, the electronic device 100 may correct the size of the standard object content projected onto the wall surface area to be greater. The electronic device 100 may differently correct the size of the standard object content projected onto the floor surface, according to the depth values, such that the size of the standard object content projected onto the boundary point with the wall surface increases from the floor surface towards the boundary point, and the size of the standard object content projected onto the boundary point decreases farther away from the boundary point with the wall surface.

The electronic device 100 may differently correct the sizes of corresponding points of the standard object content projected onto points having different depth values in the area B.

Accordingly, the entire shape and size of the projection object content projected onto the projection space may be the same as or proportional to the entire shape and size of the standard object content.

According to an embodiment, the electronic device 100 may obtain the user depth information. The user depth information may be information indicating a distance between the electronic device 100 and the user. According to an embodiment, the electronic device 100 may obtain the distance to the user using the depth sensor 106-2.

According to an embodiment, the electronic device 100 may correct the size of the standard object content using the projection space depth information and the user depth information. According to an embodiment, when a distance between the user and the projection space is close, the electronic device 100 may correct the whole size of the standard object content to be great according to the distance. According to an embodiment, when the distance between the user and the projection space is far, the electronic device 100 may correct the size of the standard object content such that the whole size of the standard object content looks small.

As such, according to an embodiment, the electronic device 100 may project the standard object content by correcting the color, brightness, and size of the standard object content using the user depth information and the modeling information about the projection space, thereby providing further realistic projection object content to the user.

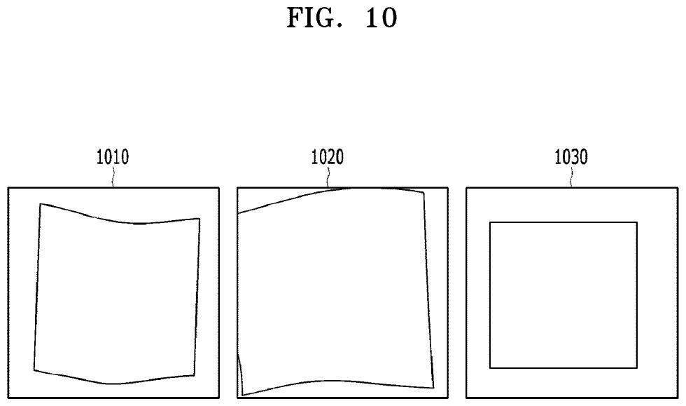

FIG. 10 is a diagram illustrating the electronic device 100 correcting the form of the standard object content, based on the modeling information corresponding to the projection space, according to various embodiments.

The projection space may be an even plane or may have a 3D effect. Distortion caused because the projection space is not a plane may be corrected through geometry correction. The geometry correction is a method inversely using a principle of projection of an image.

A reference numeral 1010 of FIG. 10 shows the standard object content projected by the electronic device 100 onto the projection space as it is, without geometry correction. When the projection space is not even and has a depth value, the standard object content projected onto the projection space is distorted due to the depth value of the projection space. Such distortion is generated when a pixel included in the standard object content is not accurately projected onto a location to be projected, but is distorted, due to the depth value of the projection space.

According to an embodiment, the electronic device 100 may perform geometry correction by obtaining information about the distortion of the standard object content and correcting the standard object content to be distorted in the other way around, by inversely using the information. According to an embodiment, the electronic device 100 may sample some of pixels included in the standard object content and correct locations for projecting the sampled pixels. According to an embodiment, the electronic device 100 may perform the geometry correction by interpolating between the pixels having the corrected locations, and compensating for the same.

A reference numeral 1020 of FIG. 10 indicates the object content on which the geometry correction is performed so as to project the standard object content without distortion onto the projection space having a depth value difference.

A reference numeral 1030 of FIG. 10 indicates the object content on which the geometry correction is performed, which is projected by the electronic device 100 onto the projection space. Unlike the reference numeral 1010, the object content on which the geometry correction is performed may be projected in the shape of the standard object content without distortion, onto the projection space having a depth value.

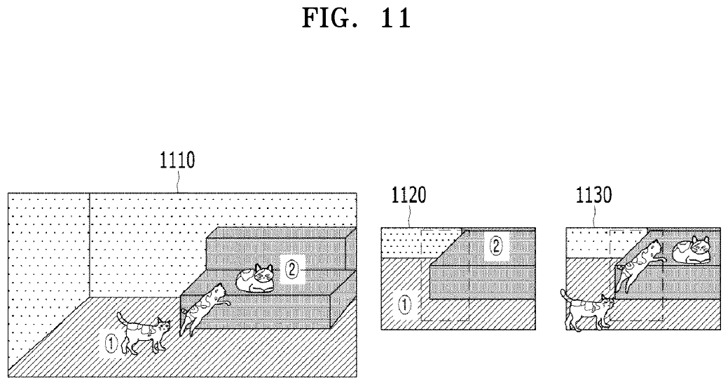

FIG. 11 is a diagram illustrating the electronic device 100 determining a movement action of the object content according to the projection space, according to various embodiments.

According to an embodiment, the electronic device 100 may obtain the modeling information corresponding to the projection space. According to an embodiment, the modeling information corresponding to the projection space may include the projection space structure information.

According to an embodiment, the electronic device 100 may determine the action of the projection object content to be an action corresponding to the projection space structure information. According to an embodiment, the projection space structure information may include the space change information.

According to an embodiment, the electronic device 100 may determine the action of the projection object content differently in the projection space in which the space change is equal to or less than the threshold value and in the projection space in which the space change is greater than the threshold value.

According to an embodiment, the projection space in which the space change is equal to or greater than the threshold value may denote a space changed by a certain size in at least one of the x-axis, the y-axis, or the z-axis.

In FIG. 11, a reference numeral 1110 may denote a case where the projection object content moves from a location 1 to a location 2. As indicated by a reference numeral 1120, the location 1 and the location 2 may each be a location changed by the threshold value or greater in the x-axis, y-axis, and x-axis.

According to an embodiment, the electronic device 100 may obtain coordinate values of each of the location 1 and the location 2, and identify whether there is a change equal to or greater than the threshold value between the locations 1 and 2, based on a difference between the coordinate values.

According to an embodiment, the action information may be divided into a first action and a second action, according to the space change of the projection space.

According to an embodiment, the first action may denote a general action that may be performed by the object content when the space change of the projection space is equal to or less than the threshold value. For example, when the standard object content is a puppy, the first action may include an action of standing still and wagging a tail, an action of crouching down, and an action or walking.

According to an embodiment, the second action may denote an action performed when the projection object content moves the projection space in which the space change is greater than the threshold value, in the projection space in which the space change is greater than the threshold value. According to an embodiment, the second action may be a different action from the first action.

According to an embodiment, the second action may be divided into different actions according to a direction of the space change. For example, the second action may be divided into different actions depending on in which one of the x-axis, y-axis, and z-axis the space change occurred.

According to an embodiment, when the y-axis denotes a height, a space between a floor and a stair may be a space having a change in a y-axis direction. In FIG. 11, it is assumed that a height difference between the floor and the stair is equal to or greater than a threshold value. According to an embodiment, the electronic device 100 may identify that there is the space change equal to or greater than the threshold value in the y-axis between the floor and the stair, and control the projection object content to perform the second action accordingly. The second action may be, for example, an action of jumping the space having the change.

According to an embodiment, when it is assumed that the x-axis denotes a width, e.g., a horizontal axis, a space between two chairs separated from each other by a threshold value or greater in a horizontal direction may be a space with a change in an x-axis direction. According to an embodiment, the electronic device 100 may control the projection object content to perform the second action when the projection object content moves between points separated from each other by a certain distance or greater in the x-axis direction. The second action may be, for example, an action of jumping.

According to an embodiment, when the z-axis denotes a depth difference, a space between spaces separated from each other by a threshold value or greater in a z-axis direction may be a space having a change in the z-axis direction. According to an embodiment, the electronic device 100 may control the projection object content to perform the second action when the projection object content moves between the spaces having a depth value difference equal to or greater than the threshold value. The second action may be, for example, an action of skipping while moving in a direction to a space having a small depth value.

According to an embodiment, the second action may be further subdivided according to a degree of the space change. For example, the second action may be divided into different actions according to a case where the space change is equal to or greater than a threshold value and equal to or less than a maximum value, and a case where the space change is greater than the maximum value.

According to an embodiment, when a space change degree is very big, for example, when a height of a stair is very large in the y-axis direction and thus a height difference between the floor and the top of the stair is greater than a pre-set maximum value, the electronic device 100 may control the projection object content to perform an action of jumping up to the top of the stair and dropping, instead of an action of jumping, among the second actions, or control the projection object content to move around the bottom of the stair.

According to an embodiment, when the space change degree is very big, for example, when the distance between the two chairs in the x-axis direction is greater than the maximum value, the electronic device 100 may control the projection object content to perform an action of jumping down to the floor from the chair and an action of jumping up to the next chair, instead of an action of jumping, among the second actions.

According to an embodiment, when the space change degree is very big, for example, when the depth difference in the z-axis is greater than the maximum value, the electronic device 100 may control the projection object content to perform, for example, an action of leaping or flying, instead of an action of skipping, among the second actions.

Referring to FIG. 11, the electronic device 100 may determine that a space between the location 1 and the location 2 is a space having a change equal to or greater than the threshold value, and control the projection object content to move the space in the second action, such as an action of jumping up to a stair, as indicated by a reference numeral 1130.

As such, according to an embodiment, the electronic device 100 may variously control a moving method of the projection object content, considering a variance of the projection space, such that the projection object content acts as if the projection object content recognizes the real space.

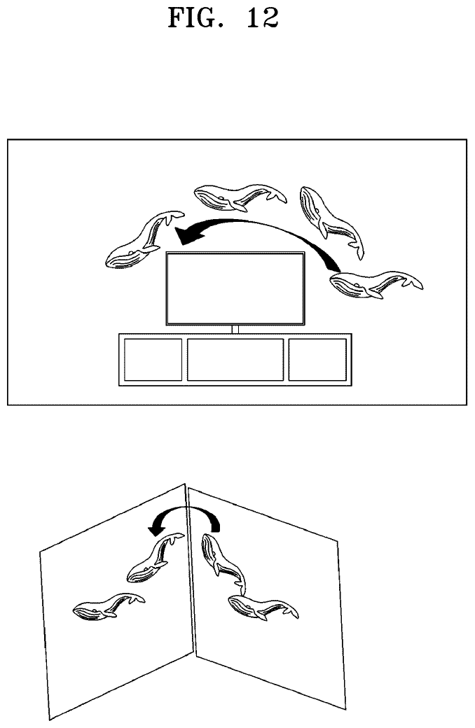

FIG. 12 is a diagram illustrating the electronic device 100 recognizing the variance in the projection space and controlling the action of the projection object content according to the variance, according to various embodiments.

According to an embodiment, the electronic device 100 may control the projection object content to act in the second action when a structure is located in the projection space where the projection object content moves. However, the present disclosure is not limited thereto, and the electronic device 100 may control the projection object content to act in the first action while controlling the action or moving direction of the projection object content such as not to collide with the structure.

Referring to FIG. 12, according to an embodiment, the electronic device 100 may obtain the modeling information corresponding to the projection space from the modeling information about the surrounding environment. An upper diagram in FIG. 12 indicates a case where the structure, such as a television or a chest of drawers, is located in the projection space. According to an embodiment, the electronic device 100 may identify a location of the structure from the modeling information corresponding to the projection space.

When the projection object content is a whale as shown in FIG. 12, according to an embodiment, the electronic device 100 may control a moving direction of the whale to move around the structure so as to prevent or avoid the whale from colliding with the structure while moving on a wall surface.

According to an embodiment, when the whale moves between wall surfaces, e.g., a corner, as shown in a lower diagram in FIG. 12, the electronic device 100 may control the moving direction of the whale to move as if the whale is turning the corner.

As such, according to an embodiment, the electronic device 100 may control the moving direction of the projection object content, considering the variance of the projection space, such that the projection object content does not collide with the structure located in the projection space. Accordingly, the user may experience more satisfactory augmented reality by recognizing the projection object content as if the projection object content recognizes a real space and acts.

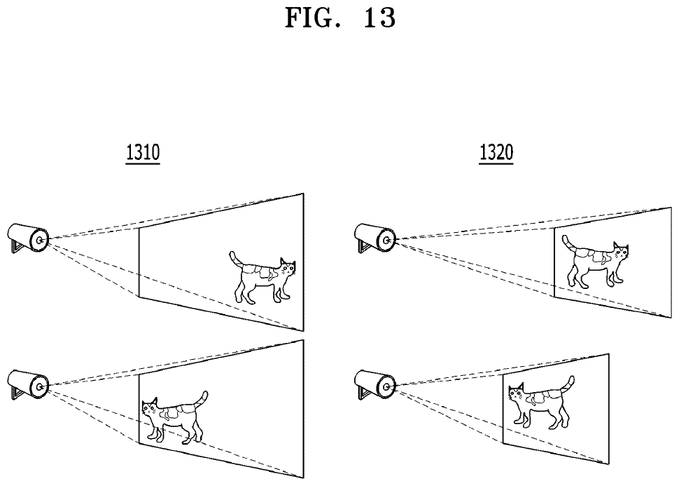

FIG. 13 is a diagram illustrating the electronic device 100 adjusting a size of the background content, according to various embodiments.

According to an embodiment, upon obtaining the standard object content, the electronic device 100 may generate the projection object content by correcting the standard object content, and generate the background content around the projection object content.

In FIG. 13, when the electronic device 100 outputs the same projection object content, the electronic device 100 differently adjusts the background content included in the projection content together with a projection object. In a left diagram 1310 of FIG. 13, the background content is relatively large, whereas in a right diagram 1320 of FIG. 13, the background content is relatively small.

According to an embodiment, the electronic device 100 may control the projection object content to act within a boundary of the background content. Accordingly, when the background content is greater, the projection object content may move in a wider area. On the other hand, when the background content is smaller, a moving radius of the background content is decreased, but the background content is not well visible to the user.

According to an embodiment, the electronic device 100 may determine the size of the background content.

According to an embodiment, the electronic device 100 may identify the structure of the surrounding space, based on the modeling information about the surrounding space, and determine the size of the background content to be large or small accordingly. For example, when the surrounding space does not include many structures and includes many simple and wide planes, the electronic device 100 may project the background content in a large size. When the surrounding space includes many structures and is complicated, the electronic device 100 may project the background content in a small size such that the background content is not well visible to the user.

According to an embodiment, the electronic device 100 may determine the size of the background content, according to the specification or model of the electronic device 100. For example, when the specification of the electronic device 100 is that the electronic device 100 is freely rotatable in various angles, for example, 360°, for each axis, the electronic device 100 may set the size of the background content to be large or to be small. The electronic device 100 may output the projection content by variously adjusting a screen size, an aspect ratio, resolution, and the like.

According to an embodiment, when the electronic device 100 does not have a rotating function or has a restriction in the rotating angle or rotating movement, the electronic device 100 may set the size of the background content to be large and control the projection object to move within the wide background content.

As such, according to an embodiment, the electronic device 100 may adjust the size of the background content variously according to various standards, and project the same.

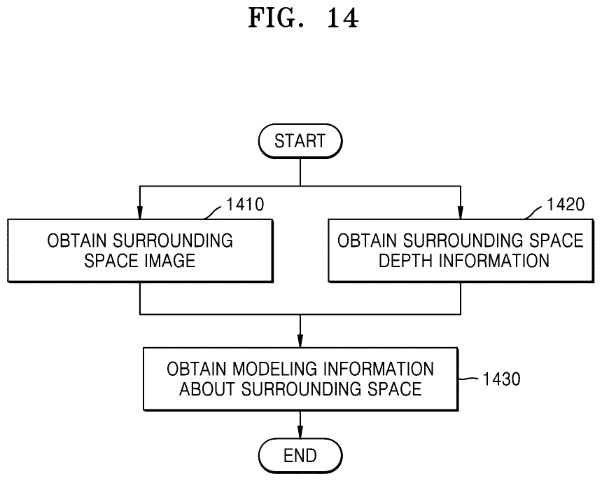

FIG. 14 is a flowchart illustrating an example method of obtaining the modeling information about the surrounding space, according to various embodiments.

Referring to FIG. 14, the electronic device 100 may obtain the surrounding space image (operation 1410). According to an embodiment, the electronic device 100 may obtain an image about the surrounding of the electronic device 100 using the image sensor 106-1.

According to an embodiment, the electronic device 100 may obtain the surrounding space depth information (operation 1420). According to an embodiment, the electronic device 100 may obtain the depth information about the surroundings of the electronic device 100 using the depth sensor 106-2.

According to an embodiment, the electronic device 100 may obtain the modeling information about the surrounding space (operation S1430). According to an embodiment, the electronic device 100 may obtain the modeling information about the surrounding space by virtually modeling the surrounding space, based on the image about the surroundings and the depth information about the surroundings. According to an embodiment, the modeling information about the surrounding space may include the color information, the luminance information, and the depth information according to the rotating angle for each axis of the electronic device 100.

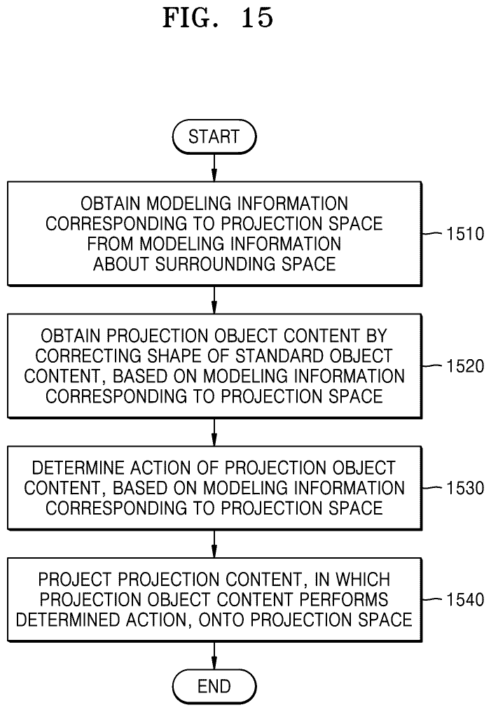

FIG. 15 is a flowchart illustrating an example method of operating the electronic device 100, according to various embodiments.

According to an embodiment, the electronic device 100 may identify the projection space. According to an embodiment, the projection space may be the direction the face of the user faces.

According to an embodiment, the electronic device 100 may obtain the user image using the image sensor 106-1, and identify the user feature point from the user image. According to an embodiment, the electronic device 100 may identify the direction the face of the user faces, based on the user feature point. According to an embodiment, the electronic device 100 may identify the space located in the direction the face of the user faces, as the projection space.

According to an embodiment, the electronic device 100 may obtain the modeling information corresponding to the projection space from the modeling information about the surrounding space (operation 1510). The electronic device 100 may obtain the modeling information of the space corresponding to the range of the projection space, among the surrounding space.

According to an embodiment, the electronic device 100 may obtain the standard object content.

According to an embodiment, the electronic device 100 may obtain the projection object content by correcting the shape of the standard object content, based on the modeling information corresponding to the projection space (operation 1520).

According to an embodiment, the electronic device 100 may correct at least one of the color, brightness, form, or size of the standard object content, based on the modeling information corresponding to the projection space.

According to an embodiment, the electronic device 100 may determine the action of the projection object content, based on the modeling information corresponding to the projection space (operation 1530). According to an embodiment, the electronic device 100 may variously determine the action of the projection object content, according to the structure of the projection space and a degree of change in the structure.

According to an embodiment, the electronic device 100 may generate the background content and generate the projection content including the projection object content and the background content.

According to an embodiment, the electronic device 100 may project the projection content, in which the projection object content performs the determined action, onto the projection space (operation 1540).

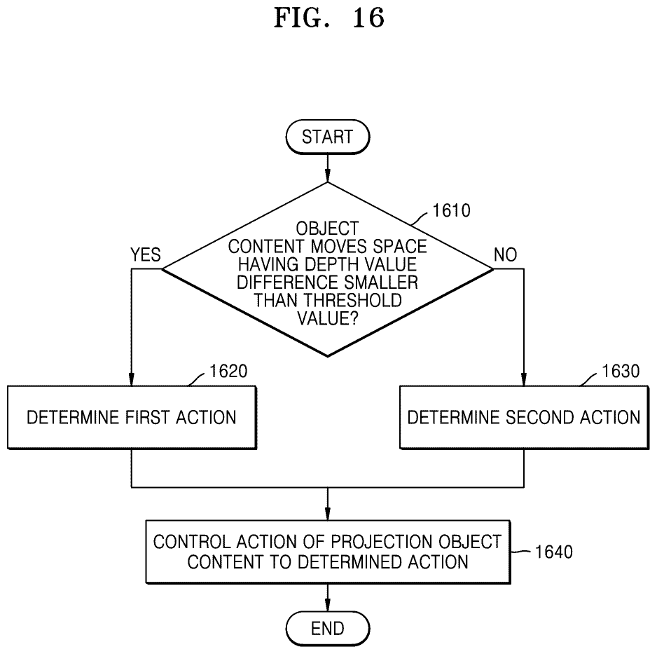

FIG. 16 is a flowchart illustrating an example process of differently controlling the action of the projection object content, based on the depth value difference of the projection space, according to various embodiments.

According to an embodiment, the electronic device 100 may control the action of the projection object content according to the structure of the space where the projection object content moves.

According to an embodiment, the electronic device 100 may control the action of the projection object content differently according to whether the change in the projection space is greater than the threshold value.

Referring to FIG. 16, according to an embodiment, the electronic device 100 may determine whether the object content moves the space having the depth value difference smaller than the threshold value (operation 1610).

According to an embodiment, when it is determined that the object content moves the space having the depth value difference smaller than the threshold value, the electronic device 100 may determine the action of the object content to be the first action (operation 1620).

According to an embodiment, when it is determined that the object content does not move the space having the depth value difference smaller than the threshold value, the electronic device 100 may determine the action of the object content to be the second action (operation 1630).

According to an embodiment, the electronic device 100 may control the action of the projection object content to the determined action (operation 1640).

The electronic device and the operating method thereof, according to various embodiments, may also be realized in the form of a recording medium including instructions executable by a computer, such as a program module executed by a computer. A computer-readable medium may be an arbitrary available medium accessible by a computer, and includes all volatile and non-volatile media and separable and non-separable media. Further, examples of the computer-readable medium may include a computer storage medium and a communication medium. Examples of the computer storage medium include all volatile and non-volatile media and separable and non-separable media, which have been implemented by an arbitrary method or technology, for storing information such as computer-readable instructions, data structures, program modules, and other data. The communication medium typically includes a computer-readable instruction, a data structure, a program module, other data of a modulated data signal, such as a carrier wave, or another transmission mechanism, and an example thereof includes an arbitrary information transmission medium.

An electronic device and an operating method thereof, according to an embodiment of the present disclosure, may be implemented by a computer program product including a computer-readable recording/storing medium having recorded thereon a program for executing the operating method including obtaining modeling information corresponding to a projection space from modeling information about a surrounding space, obtaining projection object content by correcting a shape of standard object content, based on the modeling information corresponding to the projection space, determining an action of the projection object content, based on the modeling information corresponding to the projection space, and projecting projection content including the projection object content performing the determined action, onto the projection space.

A machine-readable storage medium may be provided in the form of a non-transitory storage medium. The “non-transitory storage medium” denotes a tangible device and may not contain a signal (for example, electromagnetic waves). This term does not distinguish a case where data is stored in the storage medium semi-permanently and a case where the data is stored in the storage medium temporarily. For example, the “non-transitory storage medium” may include a buffer where data is temporarily stored.

According to an embodiment, a method according to various embodiments of the present disclosure may be provided by being included in a computer program product. The computer program products are products that can be traded between sellers and buyers. The computer program product may be distributed in the form of machine-readable storage medium (for example, a compact disc read-only memory (CD-ROM)), or distributed (for example, downloaded or uploaded) through an application store or directly or online between two user devices (for example, smart phones). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a projector;
a memory storing one or more instructions; and
at least one processor, comprising processing circuitry, individually and/or collectively, configured to execute the one or more instructions stored in the memory and to:
obtain modeling information corresponding to a projection space from modeling information about a surrounding space;
obtain projection object content by correcting a shape of standard object content, based on the modeling information corresponding to the projection space;
determine an action of the projection object content, based on the modeling information corresponding to the projection space; and
control the electronic device to project, through the projector, projection content including the projection object content performing the determined action, onto the projection space.

3. The electronic device of claim 1, wherein the modeling information corresponding to the projection space includes projection space structure information, and
at least one processor, individually and/or collectively, is configured to determine the action of the projection object content as an action corresponding to the projection space structure information.

3. The electronic device of claim 2, wherein the projection space structure information includes space change information, and
at least one processor, individually and/or collectively, is configured to:
determine the action of the projection object content as a first action, in the projection space having a space change equal to or less than a threshold value; and
determine the action of the projection object content as a second action different from the first action, in the projection space having a space change greater than the threshold value.

4. The electronic device of claim 1, wherein at least one processor, individually and/or collectively, is configured to determine the action of the projection object content, based on at least one of a specified period, a random period, or event occurrence,
wherein the event occurrence includes at least one of a location of the projection space being changed by a threshold value or greater, or a projection object content action control signal being received.

5. The electronic device of claim 1, wherein at least one processor, individually and/or collectively, is configured to correct at least one of a color, brightness, a form, or a size of the standard object content, based on the modeling information corresponding to the projection space.

6. The electronic device of claim 1, wherein the modeling information corresponding to the projection space includes projection space depth information, wherein at least one processor, individually and/or collectively, is configured to: obtain user depth information; and
correct a size of the standard object content using the projection space depth information and the user depth information.

7. The electronic device of claim 1, wherein the electronic device is rotatable based on at least one of an x-axis, a y-axis, or a z-axis, and
the electronic device further comprises an image sensor and a depth sensor,
wherein at least one processor, individually and/or collectively, is configured to obtain the modeling information about the surrounding space, based on a surrounding space image obtained through the image sensor and surrounding space depth information obtained through the depth sensor, and
the modeling information about the surrounding space includes color information, luminance information, and depth information according to a rotating angle for each axis of the electronic device.

8. The electronic device of claim 1, further comprising an image sensor,
wherein at least one processor, individually and/or collectively, is configured to: identify a user feature point from a user image obtained through the image sensor; identify a direction a user face faces, based on the user feature point; and
identify a space located in the direction the user face faces, as the projection space.

9. The electronic device of claim 1, wherein the projection content further includes background content, and
at least one processor, individually and/or collectively, is configured to determine at least one of a color or brightness of the background content, based on at least one of a color or brightness of the modeling information corresponding to the projection space.

10. The electronic device of claim 1, wherein the projection content further includes background content, and
at least one processor, individually and/or collectively, is configured to determine brightness of the background content to a minimum value.

11. A method of operating an electronic device, the method comprising:
obtaining modeling information corresponding to a projection space from modeling information about a surrounding space;
obtaining projection object content by correcting a shape of standard object content, based on the modeling information corresponding to the projection space; determining an action of the projection object content, based on the modeling information corresponding to the projection space; and
projecting projection content including the projection object content performing the determined action, onto the projection space.

12. The method of claim 11, wherein the modeling information corresponding to the projection space includes projection space structure information, and
the determining of the action of the projection object content comprises determining the action of the projection object content as an action corresponding to the projection space structure information.

13. The method of claim 12, wherein the projection space structure information includes space change information, and
the determining of the action of the projection object content as the action corresponding to the projection space structure information comprises:
determining the action of the projection object content as a first action, in the projection space having a space change equal to or less than a threshold value; and determining the action of the projection object content as a second action different from the first action, in the projection space having a space change greater than the threshold value.

14. The method of claim 11, wherein the determining of the action of the projection object content comprises determining the action of the projection object content, based on at least one of a specified period, a random period, or event occurrence, wherein the event occurrence includes at least one of a location of the projection space being changed by a threshold value or greater, or a projection object content action control signal being received.

15. A non-transitory computer-readable recording medium having recorded thereon a program which, when executed on a computer, causes an electronic device to perform the method of claim 11.
